(19) United States
(12) Patent Application Publication
(10) Pub. No.: US 2010/0118325 A1
(43) Pub. Date: May 13, 2010

(54) CONTROL BOARD OF IMAGE FORMING APPARATUS, IMAGE FORMING APPARATUS AND IMAGE FORMING METHOD

(75) Inventors: Chang-hwan KIM, Suwon-si (KR); Gun-a KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/481,743

(22) Filed: Jun. 10, 2009

(30) Foreign Application Priority Data
Nov. 10, 2008 (KR) 2008-0111178

(51) Int. Cl. G06F 3/12

(52) U.S. Cl. 358/1.13; 358/1.15

(57) ABSTRACT

An image forming apparatus includes a communication interface to receive a job, and a control board including a plurality of dedicated processors to support their respective functions and a serial interface connected each of the plurality of dedicated processors. The control board controls one of the plurality of dedicated processors corresponding to a received job to perform the received job. Accordingly, the functions of the image forming apparatus are effectively operated and may be performed in parallel with one another.

### CROSS-REFERENCE TO RELATED APPLICATIONS

This application claims priority under 35 U.S.C. §119(a) from Korean Patent Application No. 10-2008-111178, filed on Nov. 10, 2008, in the Korean Intellectual Property Office, the disclosure of which is incorporated herein by reference in its entirety.

### BACKGROUND

1. Field of the Invention

The present general inventive concept relates to a control board of an image forming apparatus, an image forming apparatus, and an image forming method, and more particularly, to a control board of an image forming apparatus, an image forming apparatus, and an image forming method of processing increasing amounts of data and performing a plurality of jobs simultaneously.

2. Description of the Related Art

Image forming apparatuses refer to apparatuses which print printing data generated by a terminal device such as a computer on a recording medium. Such image forming apparatuses may be photocopiers, printers, facsimile machines, or multifunction peripherals combining two or more of the aforementioned devices.

A control board is provided in the image forming apparatus to control various internal operations. The design and function of a conventional control board will be described below with reference to FIGS. 2 and 3.

FIGS. 2 and 3 are block diagrams illustrating a control board of a conventional image forming apparatus.

Referring to FIG. 2, a control board 10 of a conventional image forming apparatus includes a signal central processing unit (CPU) 11 to control all functions and perform all calculations of the image forming apparatus, and a plurality of functional components 12,13, and 14, (i.e., fax controller 12, image controller 13, and I/O controller 14) which are connected to the CPU 11 by a local interface (i.e., local I/F as illustrated in FIG. 2).

Referring to FIG. 3, another control board 20 of a conventional image forming apparatus includes a single CPU 21 to perform calculation and a system controller 22 to control internal functions of the image forming apparatus. The system controller 22 is connected to a plurality of functional components 23, 24 in a local interface method or a peripheral component interconnect (PCI) interface method.

However, the control boards 10 and 20, having single CPUs 11 and 21, respectively, as illustrated in FIGS. 2 and 3, have difficulty in processing a plurality of jobs simultaneously, and have a limitation on processing massive data because the various internal components are connected by the local interface.

### SUMMARY

As there is a demand for a control board capable of processing an increasing amount of data at increased speeds, and performing a plurality of jobs simultaneously, example embodiments of the present general inventive concept provide a control board of an image forming apparatus, an image forming apparatus, and an image forming method, which are capable of processing increasing amounts of data and performing a plurality of jobs simultaneously using a plurality of processors dedicated to each imaging-related function.

Additional embodiments of the present general inventive concept will be set forth in part in the description which follows and, in part, will be obvious from the description, or may be learned by practice of the general inventive concept.

Example embodiments of the present general inventive concept may be achieved by providing a control board of an image forming apparatus, the control board including a plurality of dedicated processors to support their respective functions, and a serial interface connected to each of the plurality of dedicated processors.

The dedicated processors may include at least one of a printing processor to perform a printing operation, an image processor to process scan data, and a main processor to manage the image forming apparatus.

The plurality of dedicated processors may be independently operated.

The plurality of dedicated processors may include a main processor to control transmitting a status and a command for each job.

The plurality of dedicated processors may include a printing processor, the main processor may transmit video data transmitted through a communication interface to the printing processor, and the printing processor may convert the video data into bitmap data and/or generate bitmap data, and may transmit the bitmap data to an image-forming engine unit according to a synchronization signal of the image-forming engine unit.

The plurality of dedicated processors may include an image processor and a printing processor. If a copying command is received, the image processor may control a scanning unit to scan an image, may convert and rotate scan data according to a specification of each image, compresses each image into compression data, and may transmit the compression data to the printing processor through the serial interface. The printing processor may decompress the compression data, may convert the decompressed data into bitmap data and/or generate bitmap data, and may transmit the bitmap data to an engine unit according to a synchronization signal of the engine unit.

The plurality of dedicated processors may include an image processor, and, if a scanning command is received, the image processor may control a scanning unit to scan an image and convert and rotate scan data.

The plurality of dedicated processors may include a main processor, and the main processor may control transmitting scan data processed by the image processor to a host through a communication interface.

Example embodiments of the present general inventive concept may also be achieved by providing an image forming apparatus including a communication interface to receive a job, and a control board including a plurality of dedicated processors to support their respective functions and a serial interface connected each of the plurality of dedicated processors, the control board controlling one of the plurality of dedicated processors corresponding to a received job to perform the received job.

The plurality of dedicated processors may include an image processor to correct and convert an image regarding scan data, a printing processor to convert printing data received through the communication interface or data which has been corrected and converted by the image processor into bitmap data, a fax processor to control diverse operations of a fax unit, and a main processor to classify the received job according to the type of job and transmits the job to a corresponding processor.

If the received job is a printing job, the main processor may transmit the printing job to the printing processor through the serial interface, and the printing processor may perform the printing job.

If the received job is a scanning job, the main processor may transmit the scanning job to the image processor through the serial interface, and the image processor may control the scanning unit to perform the scanning job.

If the received job is a copying job, the main processor may transmit the copying job to the image processor through the serial interface, the image processor may control the scanning unit to perform the scanning job and transmit scan data to the printing processor through the serial interface, and the printing processor may control printing the scan data.

If the received job is a faxing job, the main processor may transmit the faxing job to the fax processor through the serial interface, and the fax processor may control the fax unit according to the faxing job.

The plurality of dedicated processors may be independently operated.

Example embodiments of the present general inventive concept may also be achieved by providing an image forming method of an image forming apparatus which includes a plurality of dedicated processors to perform their respective functions and a serial interface connected to each of the plurality of dedicated processors, the method including receiving a job, selecting a dedicated processor corresponding to the job, and performing the job using the dedicated processor.

The plurality of dedicated processors may include an image processor to correct and convert an image regarding scan data, a printing processor to convert printing data received through the communication interface or data which has been corrected and converted by the image processor into bitmap data, a fax processor to control diverse operations of a fax unit, and a main processor to classify the received job according to the type of job and transmit the job to a corresponding processor.

The selecting the dedicated processor may be performed in the main processor.

If the received job is a printing job, the performing the job may include performing the printing job through the printing processor.

If the received job is a scanning job, the performing the job may include performing the scanning job through the image processor.

If the received job is a copying job, the performing the job may include performing a scanning operation through the image processor, transmitting scan data to the printing processor through the serial interface, and printing the scan data through the printing processor.

If the received job is a faxing job, the performing the job may include performing the faxing job through the fax processor.

Exemplary embodiments of the present general inventive concept may also provide an image forming apparatus, including a communication interface having groups of pins, a plurality of processors connected to the corresponding groups of pins of the communication interface, and a plurality of function units connected to the corresponding processors.

The apparatus may further include where the communication interface simultaneously transmits different data to the corresponding processors through the corresponding pins.

The apparatus may further include where the processors simultaneously and exclusively transmit different data to corresponding function units to simultaneously and exclusively perform corresponding functions.

Exemplary embodiments of the present general inventive concept may also provide an image forming apparatus, including at least one communication interface to receive a job request for the image forming apparatus, a control board having a serial interface coupled to the at least one communication interface, a plurality of discrete function processors to process the job received, a main processor to control the processing of the job request by the plurality of discrete function processors, and an image forming unit, a scanning unit and a fax unit coupled to the control board to print scan or fax data according to the job received.

Exemplary embodiments of the present general inventive concept may also provide a method of processing a plurality of imaging jobs in parallel with an image forming apparatus, the method including receiving a plurality of imaging job requests from at least one interface communicatively coupled to the image forming apparatus, classifying each of the plurality of imaging job requests, transmitting each of the classified job requests to a discrete processor, and processing each job requested based on its classification in parallel with the respective processor.

Exemplary embodiments of the present general inventive concept may also provide an image forming apparatus, including a communication interface having groups of pins to receive a job, a control board comprising a plurality of dedicated processors connected to the correspond groups of pins to support their respective functions and a serial interface connected each of the plurality of dedicated processors, the control board controlling one of the plurality of dedicated processors corresponding to a received job to perform the received job, and at least one function unit connected to at least one of the dedicated processors to perform the received job at least in part.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a block diagram illustrating an image forming apparatus according to an exemplary embodiment of the present general inventive concept;

FIGS. 2 and 3 are block diagrams illustrating a control board of a conventional image forming apparatus; and

FIG. 4 is a flowchart illustrating an image forming method according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures

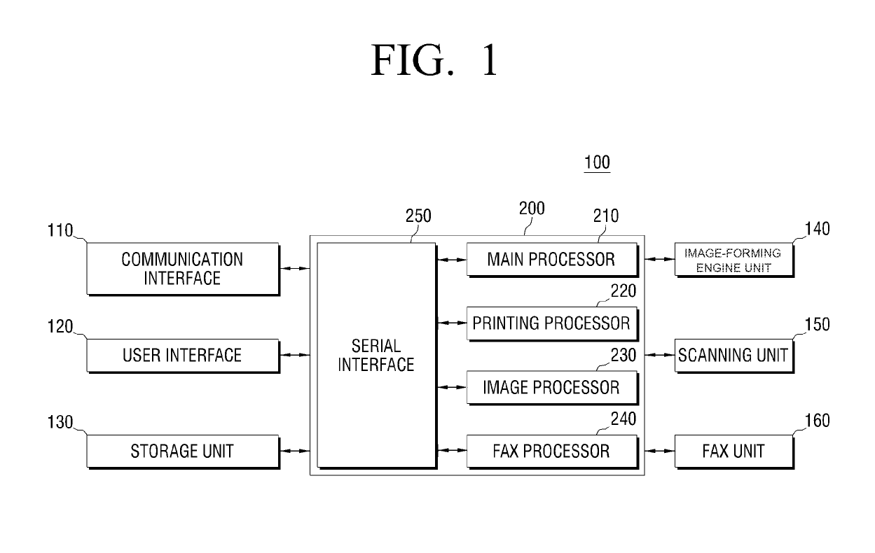

FIG. 1 is a block diagram illustrating an image forming apparatus according to an exemplary embodiment of the present general inventive concept. Referring to FIG. 1, an image forming apparatus 100 may include a communication interface 110, a user interface 120, a storage unit 130, an image-forming engine unit 140, a scanning unit 150, a fax unit 160, and a control board 200.

The communication interface 110 is connected to a terminal device (not illustrated) such as a personal computer, a laptop computer, a personal digital assistant (PDA), or a digital camera, or any other suitable device, and receives various jobs from the terminal device. More specifically, the communication interface 110 connects to the image forming apparatus 100 to an external device, and accesses the terminal device through a local area network (LAN) and the Internet as well as through a universal serial bus (USB) port, or IEEE 1284 port, or other suitable data communications port.

The “job”, as recited herein, refers to a job that can be performed in the image forming apparatus 100 and may include a printing job, a scanning job, a copying job, and a faxing job, or any combination thereof, or any other suitable job.

The user interface 120 has a plurality of function keys through which a user sets or selects various functions supported by the image forming apparatus 100, and displays various information provided by the image forming apparatus 100. The user interface 120 may be a device to implement both input and output such as a touch pad or a device combining a mouse and a monitor. A user can select a job to be performed in the image forming apparatus 100 using a user interface window provided by the user interface 120.

The storage unit 130 may store data regarding a job received through the communication interface 110 and may store various data generated inside the image forming apparatus 100. The storage unit 110 may be an internal storage medium and an external storage medium of the image forming apparatus 100, such as a removable disk or memory including a USB memory, a storage medium connected to a host, or a web server linked to a network, or any other suitable memory storage device.

The image-forming engine unit 140 performs a series of operations of forming an image on paper. More specifically, the image-forming engine unit 140 may form an image on a image-forming media using laser printing or ink jet printing, and may form a monochrome or color image. The image-forming engine unit 140 may be similar to a conventional image forming apparatus and detailed description thereof will be omitted.

The image forming engine unit 140 may include elements to feed a printing medium, print or form an image at the printing medium, and/or discharge the printing medium.

The scanning unit 150 may include a scan module to scan an image from a document. More specifically, the scanning unit 150 scans a document laid on a flatbed or a document fed from an auto document feeder (ADF), and may have a plurality of scan modules to generate image data from the scanned document.

The fax unit 160 may receive a fax transmitted through a telephone network or other telecommunication network, or transmit data of the image forming apparatus 100 through a telephone or other telecommunications network. More specifically, the fax unit 160 may be connected through a telephone network or through the Internet. The fax unit 160 may be a discrete device performing only a fax function or may be incorporated into the communication interface 110.

The image-forming engine unit 140, the scanning unit 150, and the fax unit 160 may be operated exclusively or independently according to control signals from the printing processor 220, the image processor 230, and the fax processor 240, respectively.

The control board 200 may control various internal operations of the image forming apparatus 100 to perform a job received through the communication interface 110 or a job input through the user interface 120. More specifically, the control board 200 may include a plurality of dedicated processors 210, 220, 230, 240 (e.g., main processor 210, printer processor 220, image processor 230, and fax processor 240, etc.) which are independently operated, and a serial interface 250. Although FIG. 1 illustrates processors 210, 220, 230 and 240 are coupled to the serial interface 250 as part of the control board 200, the control board 200 may include additional discrete processors, or at least one processor having multiple processors therein. The processors 210, 220, 230 and 240 may perform received jobs in parallel. That is, one or more of the processors may be performing at least one job while at least another processor is performing a job.

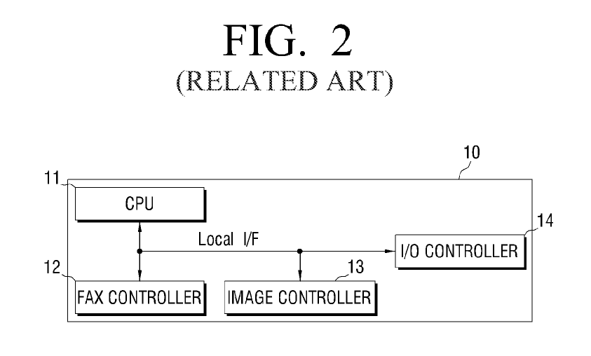

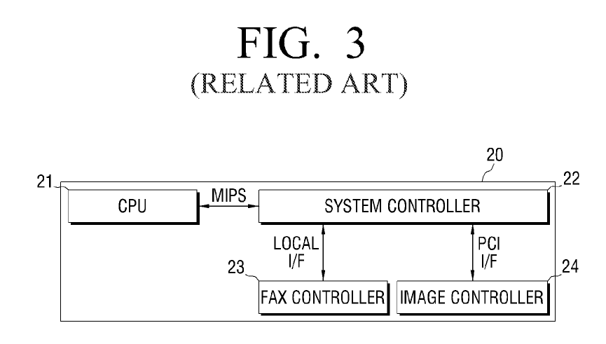

The serial interface 250 are connected each of the plurality of dedicated processors 210, 220, 230, 240. More specifically, the serial interface 250 may be connected to each of a main processor 210, a printing processor 220, an image processor 230, and a fax processor in a serial interface method to transmit and process increased amounts of data compared to the amount of data processed by the interfaces of the control boards 10 and 20 illustrated in FIGS. 2 and 3. The serial interface 250 transmits data in series using a plurality of pins to connect respective processors (e.g., processors 210, 22, 230 and 240, etc.). The serial interface 250 transmits the increasing amounts of data at high speed, compared to a typical parallel interface or the local interfaces illustrated in control boards 10 and 20 of FIGS. 2 and 3.

The plurality of dedicated processors 210, 220, 230, and 240 perform their respective functions and control various components inside the image forming apparatus 100. More specifically, the plurality of dedicated processors 210, 220, 230, 240 may include the main processor 210, the printing processor 220, the image processor 230, and the fax processor 240.

The main processor 210 may control transmitting a status and a command for each job received via the communication interface 110 or the user interface 120, or from one of the other processors (e.g., processor 220, 230, or 240). More specifically, the main processor 210 classifies the job according to the type of job received through the communication interface 110 or the user interface 120, or from one of the other processors from the serial interface 250, and transmits the job to a corresponding dedicated processor through the serial interface 250 to perform the job. The main processor 210 may check the status and the job development of each of the printing processor 220, the image processor 230, and the fax processor 240 at predetermine time intervals, upon the completion of a particular event, or at any other suitable time.

The communication interface 110, the user interface 120, and the storage unit 130 may be connected to the main processor 210 of the control board 200. The main processor 210 may control the communications interface 110, the user interface 120, and/or the storage unit 130 to transmit print job data or data to corresponding printing processor 220, image processor 230, and/or fax processor 240 through the communication interface 210. The main processor 210 may control the serial interface 250 to transmit corresponding processors 220, 230, and 240 according to a determination of the job. It is possible that the communication interface 110, the user interface 120, and the storage interface 130 may be connected to the serial interface 250 and the main processor 210.

The printing processor 220 may control the image-forming engine unit 140 to perform a printing operation. More specifically, if the printing processor 220 receives a printing job from the main processor 210, a terminal (not illustrated), or from interface 110 or 120, or receives printing data from another dedicated processor, the printing processor 220 converts received data into bitmap data and/or generates bitmap data, and transmits the bitmap data to the image-forming engine unit 140 according to a synchronization signal of the image-forming engine unit 140 to perform a printing operation. The printing processor 220 may decompress data if the data is compressed, and convert it into bitmap data and/or generate bitmap data to perform a printing operation.

The image processor 230 may control the scanning unit 150 to perform a scanning operation. More specifically, if the image processor 230 receives a job that includes a scanning operation, such as a scanning job, a copying job, and a faxing job, from the main processor 210, the image processor 230 controls the scanning unit 150 to scan a document and process the scanned image. Herein, processing an image refers to a series of operations of processing and compressing an image, such as converting size, adjusting color and converting rotation with respect to a scanned image according to a job specification of each job, or any other suitable image processing operations.

The image processor 230 transmits scan data to another dedicated processor through the serial interface 250 according to the type of job if the scanning operation has been completed. For example, if the received job is a copying job, the image processor 230 transmits scan data to the printing processor 220 through the serial interface 250 to print the scan data using the printing processor 220 and the image-forming engine unit 140. In this example, the main processor 210 may facilitate communication between the image processor 230 and the printing processor 220.

If the received job is a fax transmitting job, the image processor 230 transmits scan data to the fax processor 240 through the serial interface 250 to fax the scan data through the fax unit 160. In some embodiments, main processor 210 may facilitate, monitor, or control communication of data, commands, or jobs between the image processor 230 and the fax processor 240 via the serial interface 250.

If the received job is a scanning job, the image processor 230 transmits scan data to the main processor 210 through the serial interface 250 to store the scan data to the storage unit 130 of the image forming apparatus 100 or transmit the scan data to a terminal device (not illustrated). In some embodiments, main processor 210 may facilitate, monitor, or control communication of data, commands, or jobs between the image processor 230 and the data storage unit 130.

The fax processor 240 may control the fax unit 160 to perform a faxing operation. More specifically, if the fax processor 240 receives a faxing job from the main processor 210, receives scan data from the image processor 230, or receives a fax receiving job through the fax unit 160, the fax processor 240 controls the fax unit 160 to perform a fax transmitting job and a faxing receiving job. The fax processor 240 may also receive a faxing job from the communication interface 110 via the serial interface 250.

For example, if the fax processor 240 receives a fax transmitting job from the main processor 210, the fax processor 240 controls the fax unit 160 to transmit data regarding the fax transmitting job.

If a fax is received at the image forming apparatus 100, the fax unit 160 notifies the main processor 210 or the fax processor 240 of the receipt of the fax. Accordingly, the fax processor 240, which acknowledges a fax receiving job, converts received fax data to data that can be processed by the printing processor 220, and transmits the data to the printing processor 220 through the serial interface 250.

The fax processor 240 may transmit the received fax data directly to the printing processor 220, or may store the fax data to the storage unit 130 before transmitting the data to the printing processor 220 for printing.

As described above, the image forming apparatus 100 includes the dedicated processors 210, 220, 230, and 240 which are divided by function, thereby performing a plurality of jobs simultaneously. Also, each of the dedicated processor is connected to the high speed serial interface 250, thereby easily processing increased amounts of data and thus effectively managing data and enhancing entire system performance compared to the control boards 10 and 20 illustrated in FIGS. 2 and 3.

According to the present general inventive concept, the printing processor 220 and the image processor 230 may be formed as a single processor to exclusively operate from the fax processor 240. The printing processor 220 and the fax processor 240 may be formed as a single processor to exclusively operate from the image processor 230. The image processor 230 and the fax processor 240 may be formed as a single processor to exclusively operate from the printing processor 220.

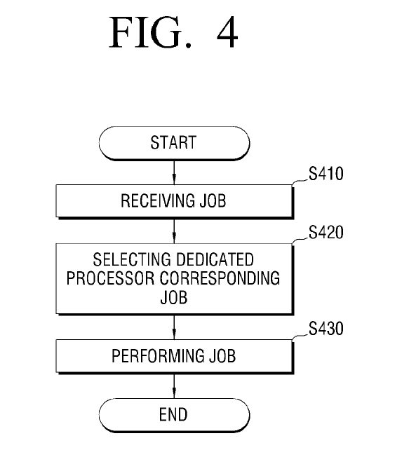

FIG. 4 is a flowchart illustrating an image forming method according to an exemplary embodiment of the present general inventive concept.

If a job is received in operation S410, a dedicated processor corresponding to the job is selected in operation S420. More specifically, it is determined which of a copying job, a printing job, a scanning job, and a faxing job is received and a dedicated processor to perform a corresponding job is selected. For example, if a job is received, the main processor 210 may determine that the job is a printing job, and transmits the printing job to the printing processor 220 through the serial interface 250 to perform the printing job. The main processor 210 may determine that the job is a printing job based on, for example, header information in the job request, or based on other data transmitted with the job.

The dedicated processor corresponding to the job performs the job in operation S430. More specifically, if a printing job is received, the printing processor 220 performs the printing job, if a scanning job is received, the image processor 230 performs the scanning job, if faxing job is received, the fax processor 240 performs the faxing job, and if a copying job is received, the image processor 230 performs a scanning operation and the printing processor prints the scan data. Since the operation of each of the dedicated processors corresponding to each job was described above with reference to FIG. 1, detailed description is omitted.

Accordingly, one of the plurality of dedicated processors is selected according to the type of a received job to perform the job, so that even if several different types of jobs are received, the dedicated processors can perform these jobs simultaneously. For example, if a scanning job, a printing job, a faxing job, and a copying job are received via the serial interface from the communications interface 110, the user interface 120, or from one of the processors, 210, 220, 230, or 240, the main processor 210 determines that these jobs are scanning, printing, faxing, and copying jobs, and directs them to image processor 230, printing processor 220, fax processor 240, and image processor 230, respectively for printing with the image forming engine unit 140, for scanning and copying with the scanning unit 150, and faxing with the fax unit 160. The main processor 210 may control the input of the plurality of jobs and output of image processors 220, 230, and 240 to image forming engine unit 140, scanning unit 150, and fax unit 160. That is, main processor 210 may monitor and control the parallel processing of jobs by the processors 220, 230 and 240. The image forming method of FIG. 4 can be executed in a different image forming apparatus, besides the image forming apparatus of FIG. 2.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A control board of an image forming apparatus, the control board comprising:
a plurality of dedicated processors to support their respective functions; and
a serial interface connected to each of the plurality of dedicated processors.

2. The control board of the image forming apparatus as claimed in claim 1, wherein the dedicated processors comprise at least one of a printing processor to perform a printing operation, an image processor to process scan data, and a main processor to manage the image forming apparatus.

3. The control board of the image forming apparatus as claimed in claim 1, wherein the plurality of dedicated processors are independently operated.

4. The control board of the image forming apparatus as claimed in claim 1, wherein the plurality of dedicated processors comprises:
a main processor to control transmitting a status and a command for each job.

5. The control board of the image forming apparatus as claimed in claim 4, wherein the plurality of dedicated processors comprise a printing processor,
wherein the main processor transmits video data transmitted through a communication interface to the printing processor,
wherein the printing processor converts the video data into bitmap data and/or generates bitmap data, and transmits the bitmap data to an image-forming engine unit according to a synchronization signal of the image forming engine unit.

6. The control board of the image forming apparatus as claimed in claim 1, wherein the plurality of dedicated processors comprise an image processor and a printing processor,
wherein, if a copying command is received, the image processor controls a scanning unit to scan an image, converts and rotates scan data according to a specification of each image, compresses each image into compression data, and transmits the compression data to the printing processor through the serial interface,
wherein the printing processor decompresses the compression data, generates bitmap data from at least a portion of the the decompressed data, and transmits the bitmap data to an engine unit according to a synchronization signal of the engine unit.

7. The control board of the image forming apparatus as claimed in claim 1, wherein the plurality of dedicated processors comprise:
an image processor,
wherein, if a scanning command is received, the image processor controls a scanning unit to scan an image and converts and rotates scan data.

8. The control board of the image forming apparatus as claimed in claim 7, wherein the plurality of dedicated processors comprise:
a main processor,
wherein the main processor controls transmitting scan data processed by the image processor to a host through a communication interface.

9. An image forming apparatus comprising:
a communication interface to receive a job; and
a control board comprising a plurality of dedicated processors to support their respective functions and a serial interface connected each of the plurality of dedicated processors, the control board controlling one of the plurality of dedicated processors corresponding to a received job to perform the received job.

10. The image forming apparatus as claimed in claim 9, wherein the plurality of dedicated processors comprise:
an image processor to correct and convert an image regarding scan data;
a printing processor to convert printing data received through the communication interface or data which has been corrected and converted by the image processor into bitmap data;
a fax processor to control diverse operations of a fax unit; and
a main processor to classify the received job according to the type of job and transmits the job to a corresponding processor.

11. The image forming apparatus as claimed in claim 10, wherein, if the received job is a printing job, the main processor transmits the printing job to the printing processor through the serial interface, and the printing processor performs the printing job.

12. The image forming apparatus as claimed in claim 10, wherein, if the received job is a scanning job, the main processor transmits the scanning job to the image processor through the serial interface, and the image processor controls the scanning unit to perform the scanning job.

13. The image forming apparatus as claimed in claim 10, wherein, if the received job is a copying job, the main processor transmits the copying job to the image processor through the serial interface, the image processor controls the scanning unit to perform the scanning job and transmits scan data to the printing processor through the serial interface, and the printing processor controls printing the scan data.

14. The image forming apparatus as claimed in claim 10, wherein, if the received job is a faxing job, the main processor transmits the faxing job to the fax processor through the serial interface, and the fax processor controls the fax unit according to the faxing job.

15. The image forming apparatus as claimed in claim 9, wherein the plurality of dedicated processors are independently operated.

16. An image forming method of an image forming apparatus which comprises a plurality of dedicated processors to perform their respective functions and a serial interface connected to each of the plurality of dedicated processors, the method comprising:
receiving a job;
selecting a dedicated processor corresponding to the job; and
performing the job using the dedicated processor.

17. The image forming method as claimed in claim 16, further comprising:
correcting and converting an image regarding scan data with an image processor;
converting printing data received through the communication interface or data which has been corrected and converted by the image processor into bitmap data with a printing processor;
controlling diverse operations of a fax unit with a fax processor; and
classifying the received job according to the type of job and transmitting the job to a corresponding processor with a main processor.

18. The image forming method as claimed in claim 17, wherein the selecting the dedicated processor is performed in the main processor.

19. The image forming method as claimed in claim 17, wherein:
if the received job is a printing job, the performing the job comprises performing the printing job through the printing processor,
if the received job is a scanning job, the performing the job comprises performing the scanning job through the image processor,
if the received job is a copying job, the performing the job comprises:
performing a scanning operation through the image processor;
transmitting scan data to the printing processor through the serial interface; and
printing the scan data through the printing processor, and if the received job is a faxing job, the performing the job comprises:
performing the faxing job through the fax processor.

20. A method of processing a plurality of imaging jobs in parallel with an image forming apparatus, comprising:
receiving a plurality of imaging job requests from at least one interface communicatively coupled to the image forming apparatus;
classifying each of the plurality of imaging job requests;
transmitting each of the classified job requests to a discrete processor; and
processing each job requested based on its classification in parallel with the respective processor.
